(19) United States
(12) Patent Application Publication
(10) Pub. No.: US 2026/0121744 A1
(43) Pub. Date: Apr. 30, 2026

(54) MEASUREMENT SYSTEM AND MEASUREMENT METHOD

(71) Applicant: NEC Corporation, Tokyo (JP)

(72) Inventors: John Kenji David CLARK, Tokyo (JP); Tatsunori Omiya, Tokyo (JP); Toshifumi Nakamura, Tokyo (JP)

(73) Assignee: NEC Corporation, Tokyo (JP)

(21) Appl. No.: 19/359,906

(22) Filed: Oct. 16, 2025

(30) Foreign Application Priority Data
Oct. 28, 2024 (JP) 2024-188996

(51) Int. Cl. H04B 10/075; H04B 10/40; H04B 10/508; H04B 10/54; H04B 10/548; H04B 10/61; H04J 14/06

(52) U.S. Cl. CPC H04B 10/075; H04B 10/40; H04B 10/508; H04B 10/54; H04B 10/548; H04B 10/613; H04B 10/6151; H04J 14/06

(57) ABSTRACT

A light source outputs a first optical signal having a first wavelength to a wavelength converter including a reception unit and transmission unit. The reception unit coherently detects an optical signal having the first wavelength and outputs analog signals associated to a plurality of phases. The transmission unit multiplexes a plurality of optical signals and outputs the optical signals as second optical signals and includes a driver and modulators modulating light having a second wavelength to the plurality of optical signals according to modulation signals from the driver. A controller controls the wavelength converter so that one specific modulation unit outputs an optical signal, the other modulators do not output optical signals, and the specific modulation unit is sequentially switched. A measurement unit acquires waveforms of optical signals having the plurality of phases from the second optical signal and measures skew based on intensities of the waveforms.

### INCORPORATION BY REFERENCE

This application is based upon and claims the benefit of priority from Japanese patent application No. 2024-188996, filed on Oct. 28, 2024, the disclosure of which is incorporated herein in its entirety by reference.

### TECHNICAL FIELD

The present disclosure relates to a measurement system and a measurement method.

### BACKGROUND ART

As a device used in an optical network, a wavelength converter for converting an optical signal of a certain wavelength into an optical signal of another wavelength is known. For example, as disclosed in WO 2011/145712 A1, a wavelength converter that wavelength-converts a quadrature phase-modulated optical signal including an in-phase (I) phase and a quadrature (Q) phase orthogonal to each other is widely used.

The wavelength converter converts the received optical signal into an analog signal by coherent detection. Then, by modulating light having a wavelength different from that of the received optical signal based on the converted analog signal, an optical signal having another wavelength is output. In the coherent detection, a received signal is branched into two. Thereafter, by causing one branched optical signal to interfere with local oscillation light, an I-phase optical signal is generated. In addition, by causing the other branched optical signal to interfere with local oscillation light of which the phase is shifted by 90°, a Q-phase optical signal is generated. Then, by photoelectrically converting the I-phase and Q-phase optical signals, I-phase and Q-phase analog signals can be obtained.

At this time, if wavelength conversion is performed by the wavelength converter, the delay time of the optical signal of each phase included in the optical signal after the wavelength conversion varies, which is referred to as skew. Since occurrence of skew leads to deterioration in quality of the optical signal after wavelength conversion output from the wavelength converter, it is required to measure the skew and reduce the skew.

Various skew measurement methods have been proposed, and for example, WO 2011/145712 A1 proposes a method for measuring skew occurring in an optical receiver. In addition, US 2017/324476 A1 proposes a method for measuring skew occurring in an optical transmitter.

### SUMMARY

However, since the wavelength converter has a configuration in which the transmitter and the receiver are coupled, it is difficult to measure the contribution of each of the transmitter and the receiver to the skew occurring in the optical signal wavelength-converted by the wavelength converter with high accuracy by the above-described method.

According to an example aspect of the present disclosure, a measurement system includes a light source that outputs a first optical signal having a first wavelength to a reception means of a wavelength converter configured with the reception means for coherently detecting an input optical signal having the first wavelength and outputting a plurality of analog signals associated to a plurality of phases included in the input optical signal having the first wavelength and a transmission means for multiplexing a plurality of optical signals and outputting the optical signals, the transmission means including a drive means for outputting a plurality of modulation signals according to the plurality of analog signals and a plurality of modulation means for modulating light having a second wavelength different from the first wavelength to the plurality of optical signals associated to the plurality of phases according to the plurality of modulation signals, a control means for controlling the wavelength converter in a state in which the first optical signal is output to the reception means, so that one specific modulation means among the plurality of modulation means outputs an optical signal associated to one phase, the optical signal obtained by modulating the light having the second wavelength, the modulation means other than the specific modulation means do not output optical signals associated to phases other than the one phase, and the specific modulation means is sequentially switched among the plurality of modulation means, and a measurement means for receiving a second optical signal output from the transmission means in a state in which the first optical signal is output to the reception means, acquiring waveforms of optical signals associated to the plurality of phases selectively included in the second optical signal in response to the switching of the specific modulation means, and measuring skew occurring in the optical signals associated to the plurality of phases based on intensities of the acquired waveforms of the optical signals associated to the plurality of phases.

According to an example aspect of the present disclosure, a measurement system includes a wavelength converter configured with a reception means for coherently detecting an input optical signal having a first wavelength and outputting a plurality of analog signals associated to a plurality of phases included in the input optical signal having the first wavelength and a transmission means for multiplexing a plurality of optical signals and outputting the optical signals, the transmission means including a drive means for outputting a plurality of modulation signals according to the plurality of analog signals and a plurality of modulation means for modulating light having a second wavelength different from the first wavelength to the plurality of optical signals associated to the plurality of phases according to the plurality of modulation signals, a light source that outputs a first optical signal having the first wavelength to the reception means, a control means for controlling the wavelength converter in a state in which the first optical signal is output to the reception means, so that one specific modulation means among the plurality of modulation means outputs an optical signal associated to one phase, the optical signal obtained by modulating the light having the second wavelength, the modulation means other than the specific modulation means do not output optical signals associated to phases other than the one phase, and the specific modulation means is sequentially switched among the plurality of modulation means, and a measurement means for receiving a second optical signal output from the transmission means in a state in which the first optical signal is output to the reception means, acquiring waveforms of optical signals associated to the plurality of phases selectively included in the second optical signal in response to the switching of the specific modulation means, and measuring skew occurring in the optical signals associated to the plurality of phases based on intensities of the acquired waveforms of the optical signals associated to the plurality of phases.

According to an example aspect of the present disclosure, a measurement method includes outputting a first optical signal having a first wavelength to a reception means of a wavelength converter configured with the reception means for coherently detecting an input optical signal having the first wavelength and outputting a plurality of analog signals associated to a plurality of phases included in the input optical signal having the first wavelength and a transmission means for multiplexing a plurality of optical signals and outputting the optical signals, the transmission means including a drive means for outputting a plurality of modulation signals according to the plurality of analog signals and a plurality of modulation means for modulating light having a second wavelength different from the first wavelength to the plurality of optical signals associated to the plurality of phases according to the plurality of modulation signals, controlling the wavelength converter in a state in which the first optical signal is output to the reception means, so that one specific modulation means among the plurality of modulation means outputs an optical signal associated to one phase, the optical signal obtained by modulating the light having the second wavelength, the modulation means other than the specific modulation means do not output optical signals associated to phases other than the one phase, and the specific modulation means is sequentially switched among the plurality of modulation means, and receiving a second optical signal output from the transmission means in a state in which the first optical signal is output to the reception means, acquiring waveforms of optical signals associated to the plurality of phases selectively included in the second optical signal in response to the switching of the specific modulation means, and measuring skew occurring in the optical signals associated to the plurality of phases based on intensities of the acquired waveforms of the optical signals associated to the plurality of phases.

According to the present disclosure, it is possible to measure skew occurring between a plurality of phases included in an optical signal subjected to wavelength conversion by a wavelength converter.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram schematically illustrating a configuration of a wavelength converter according to one example embodiment;

FIG. 2 is a diagram schematically illustrating a configuration of a reception unit of the wavelength converter according to one example embodiment;

FIG. 3 is a diagram schematically illustrating a configuration of a transmission unit of the wavelength converter according to one example embodiment;

FIG. 4 is a diagram schematically illustrating a configuration of a measurement system of skew occurring in the wavelength converter according to one example embodiment;

FIG. 5 is a flowchart illustrating measurement of the skew occurring in the wavelength converter according to one example embodiment;

FIG. 6 is a diagram illustrating a waveform of an optical signal of each phase output from the wavelength converter according to one example embodiment;

FIG. 7 is a diagram illustrating a measured waveform in a case where a delay time difference between two phases is larger than a cycle of the optical signal;

FIG. 8 is a diagram schematically illustrating a configuration of the measurement system according to one example embodiment;

FIG. 9 is a flowchart illustrating a determination method of a cycle of the optical signal;

FIG. 10 is a diagram illustrating a configuration of the measurement system according to one example embodiment;

FIG. 11 is a diagram illustrating a modified example of the measurement system according to one example embodiment;

FIG. 12 is a diagram schematically illustrating a first configuration example of a measurement light source;

FIG. 13 is a diagram schematically illustrating a second configuration example of the measurement light source; and

FIG. 14 is a diagram schematically illustrating a third configuration example of the measurement light source.

### EXAMPLE EMBODIMENTS

Hereinafter, example embodiments of the present invention are described with reference to the diagrams. In the diagrams, the same elements are denoted by the same reference numerals, and repeated description is omitted as necessary.

Hereinafter, the term “one example embodiment” means that it is applicable to any of the example embodiments described below or a combination of two or more example embodiments, and the application is not limited to a specific example embodiment.

### First Example Embodiment

A wavelength converter according to a first example embodiment is described. The wavelength converter is configured to convert a wavelength of a multiplexed optical signal. Hereinafter, the present example embodiment is described with an assumption that the wavelength converter performs wavelength conversion of an optical signal subjected to Dual-Polarization Quadrature Phase-Shift-Keying (DP-QPSK).

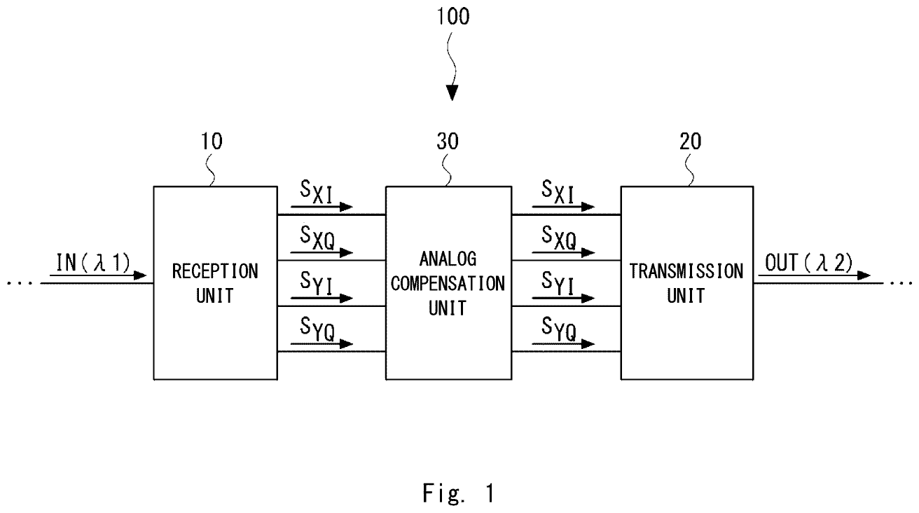

FIG. 1 is a diagram schematically illustrating a configuration of a wavelength converter according to one example embodiment. A wavelength converter 100 is configured with a reception unit 10, a transmission unit 20, and an analog compensation unit 30. The reception unit 10 is configured as a so-called coherent reception front end of the wavelength converter 100. The transmission unit 20 is configured as a so-called coherent transmission front end of the wavelength converter 100.

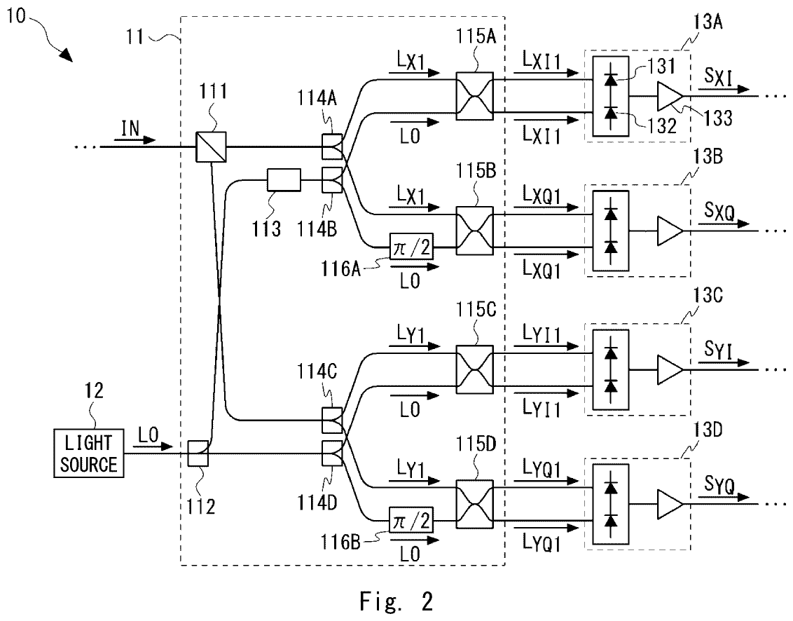

The configuration of the wavelength converter 100 is described in more detail. FIG. 2 is a diagram schematically illustrating a configuration of a reception unit of the wavelength converter according to one example embodiment.

The reception unit 10 receives an input of a DP-QPSK-modulated optical signal IN having a wavelength λ1. Hereinafter, the wavelength λ1 is also referred to as a first wavelength. The reception unit 10 outputs in-phase (I-phase) and quadrature phase (Q-phase) analog signals for an X polarized wave and a Y polarized wave by coherently detecting the optical signal IN. Note that, hereinafter, the I phase of the X polarized wave is referred to as XI, and the Q phase is referred to as XQ. The I phase of the Y polarized wave is referred to as YI, and the Q phase is referred to as YQ.

The reception unit 10 is configured with a 90° hybrid circuit 11, a light source 12, and photoelectric converters 13A to 13D.

The 90° hybrid circuit 11 is configured with a Polarizing Beam Splitter (PBS) 111, a 1×2 optical coupler 112, a polarization rotator 113, 1×2 optical couplers 114A to 114D, 2×2 optical couplers 115A to 115D, and phase shifters 116A and 116B.

The PBS 111 performs polarization separation on the input optical signal IN into an X polarized wave optical signal L_{X1} and a Y polarized wave optical signal L_{Y1}. The X polarized wave optical signal L_{X1} is branched into the 2×2 optical coupler 115A and the 2×2 optical coupler 115B by the 1×2 optical coupler 114A. The Y polarized wave optical signal L_{Y1} is branched into the 2×2 optical coupler 115C and the 2×2 optical coupler 115D by the 1×2 optical coupler 114C.

The light source 12 is configured as, for example, a wavelength variable laser light source and outputs local oscillation light LO having the wavelength λ1. The local oscillation light LO is branched into the polarization rotator 113 and the 1×2 optical coupler 114D by the 1×2 optical coupler 112. The polarization rotator 113 rotates the polarization plane of the local oscillation light LO by 90° and then outputs the local oscillation light LO to the 1×2 optical coupler 114B. The 1×2 optical coupler 114B branches the input local oscillation light LO after polarization rotation into the 2×2 optical coupler 115A and the phase shifter 116A. The phase shifter 116A applies a phase shift of π/2 to the input local oscillation light LO and then outputs the local oscillation light LO to the 2×2 optical coupler 115B. The 1×2 optical coupler 114D branches the input local oscillation light LO into the 2×2 optical coupler 115C and the phase shifter 116B. The phase shifter 116B applies a phase shift of π/2 to the input local oscillation light LO and then outputs the local oscillation light LO to the 2×2 optical coupler 115D.

The 2×2 optical coupler 115A outputs an XI optical signal L_{XI1} obtained by causing the X polarized wave optical signal L_{X1} and the local oscillation light LO to interfere with each other to the photoelectric converter 13A via two output ports. The 2×2 optical coupler 115B outputs an XQ optical signal L_{XQ1} obtained by causing the X polarized wave optical signal L_{X1} and the local oscillation light LO to which the phase shift of π/2 is applied to interfere with each other to the photoelectric converter 13B via two output ports. The 2×2 optical coupler 115C outputs a YI optical signal Lyn obtained by causing the Y polarized wave optical signal L_{Y1} and the local oscillation light LO to interfere with each other to the photoelectric converter 13C via two output ports. The 2×2 optical coupler 115D outputs a YQ optical signal L_{YQ1} obtained by causing the Y polarized wave optical signal L_{Y1} and the local oscillation light LO to which the phase shift of π/2 is applied to interfere with each other to the photoelectric converter 13D via two output ports.

The photoelectric converters 13A to 13D are configured as a balance type detector in which two photodiodes (hereinafter, referred to as PD) are connected in cascade. Here, a PD 131 on the upper side of the drawing is defined as the + side, and a PD 132 on the lower side of the drawing is defined as the − side. The photoelectric converters 13A to 13D receive the XI optical signal L_{XI1}, the XQ optical signal L_{XQ1}, the YI optical signal Lyn, and the YQ optical signal L_{YQ1} which are output from two output ports of the 2×2 optical couplers 115A to 115D. Also, the photoelectric converters 13A to 13D convert current signals output from the node between the two PDs 131 and 132 into analog signals S_{XI}, S_{XQ}, S_{YI}, and S_{YQ} of XI, XQ, YI, and YQ by, for example, a transimpedance amplifier 133.

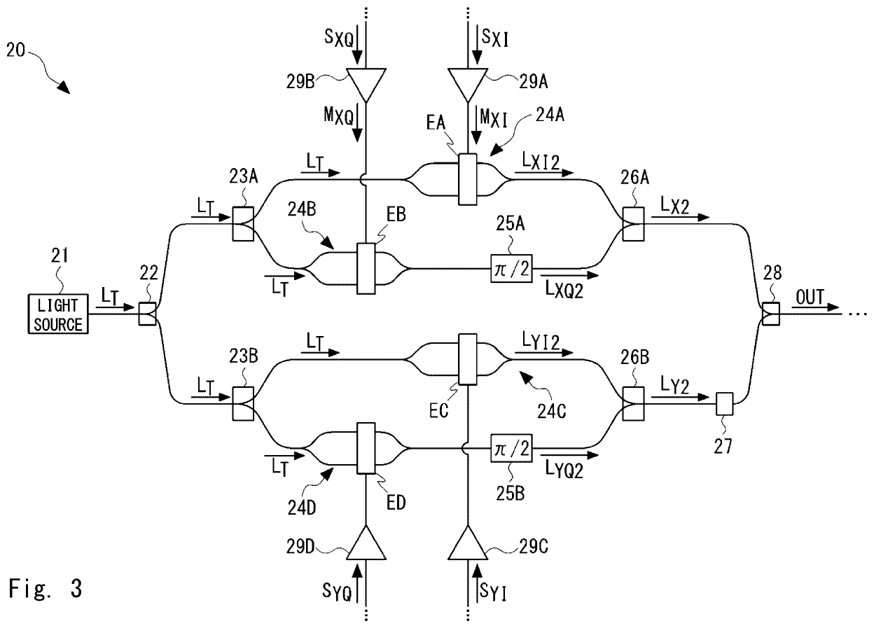

The analog compensation unit 30 appropriately performs a compensation process on the analog signals S_{XI}, S_{XQ}, S_{YI}, and S_{YQ}. Then, the analog compensation unit 30 outputs the compensated analog signals S_{XI}, S_{XQ}, S_{YI}, and S_{YQ} to the transmission unit 20. The analog signals S_{XI}, S_{XQ}, S_{YI}, and S_{YQ} are differential analog signals and may be configured with + analog signals and − analog signals. In a case where the analog signals S_{XI}, S_{XQ}, S_{YI}, and S_{YQ} are differential analog signals, each of the analog signals S_{XI}, S_{XQ}, S_{YI}, and Syo may be compensated by a positive analog compensator or a negative analog compensator in the analog compensation unit 30. Also, in the analog compensation unit 30, each of the analog signals S_{XI}, S_{XQ}, S_{YI}, and S_{YQ} may be compensated by a differential analog compensator having a differential input. FIG. 3 is a diagram schematically illustrating a configuration of a transmission unit of the wavelength converter according to one example embodiment. The transmission unit 20 outputs a DP-QPSK-modulated optical signal OUT by modulating the light having a wavelength λ2 based on the analog signals S_{XI}, S_{XQ}, S_{YI}, and S_{YQ}. Hereinafter, the wavelength λ2 is also referred to as a second wavelength.

The transmission unit 20 is configured with a light source 21, 1×2 optical couplers 22, 23A, and 23B, Mach-Zehnder optical modulators (hereinafter, MZ optical modulators) 24A to 24D, phase shifters 25A and 25B, 2×1 optical couplers 26A and 26B, a polarization rotator 27, a polarization beam coupler 28, and drivers 29A to 29D.

The light source 21 is configured as, for example, a wavelength variable laser light source and outputs transmission light L_{T} having the wavelength λ2 to the 1×2 optical coupler 22. The 1×2 optical coupler 22 branches the transmission light L_{T} into the 1×2 optical coupler 23A and the 1×2 optical coupler 23B. The 1×2 optical coupler 23 A branches the input transmission light L_{T} into the MZ optical modulator 24A and the MZ optical modulator 24B. The 1×2 optical coupler 23B branches the input transmission light L_{T} into the MZ optical modulator 24C and the MZ optical modulator 24D.

Each of the MZ optical modulators 24A to 24D branches the transmission light L_{T} into two arms. Electrodes EA to ED are provided in two arms of each of the MZ optical modulators 24A to 24D. Modulation signals M_{XI}, M_{XQ}, M_{YI}, and M_{YQ} output from the drivers 29A to 29D that drive the modulators 24A to 24D are applied to the electrodes EA to ED, respectively, based on the analog signals S_{XI}, S_{XQ}, S_{YI}, and S_{YQ} received from the analog compensation unit 30. In the drawing, each of the electrodes EA to ED is represented as one electrode, but this is merely an example. Each of the electrodes EA to ED is a pair of two electrodes provided in each of the two arms, and each of the modulation signals M_{XI}, M_{XQ}, M_{YI}, and M_{YQ} may be a pair of two signals applied to the two electrodes.

The MZ optical modulator 24A outputs an XI optical signal L_{XI2} having the wavelength λ2 obtained by modulating the transmission light L_{T} according to the modulation signal M_{XI} to the 2×1 optical coupler 26A. The MZ optical modulator 24B outputs an XQ optical signal L_{XQ2} having the wavelength λ2 obtained by modulating the transmission light L_{T} according to the modulation signal M_{XQ} to the phase shifter 25A. The phase shifter 25A applies a phase shift of π/2 to the XQ optical signal L_{XQ2} and outputs the signal to the 2×1 optical coupler 26A. As a result, the 2×1 optical coupler 26A multiplexes the XI optical signal L_{XI2} and the XQ optical signal L_{XQ2} of which the phase is delayed by π/2 with respect to the XI optical signal L_{XI2} to the X polarized wave optical signal L_{X2} subjected to the phase shift modulation. The 2×1 optical coupler 26A outputs the X polarized wave optical signal L_{X2} to the polarization beam coupler 28.

The MZ optical modulator 24C outputs a YI optical signal L_{YI2} having the wavelength λ2 obtained by modulating the transmission light L_{T} according to the modulation signal My to the 2×1 optical coupler 26B. The MZ optical modulator 24D outputs a YQ optical signal L_{YQ2} having the wavelength λ2 obtained by modulating the transmission light L_{T} according to the modulation signal Myo to the phase shifter 25B. The phase shifter 25B applies a phase shift of π/2 to the YQ optical signal L_{YQ2} and outputs the signal to the 2×1 optical coupler 26B. As a result, the 2×1 optical coupler 26B multiplexes the YI optical signal L_{YI2} and the YQ optical signal L_{YQ2} of which the phase is delayed by π/2 with respect to the YI optical signal L_{YI2} to the Y polarized wave optical signal L_{Y2} subjected to the phase shift modulation. The 2×1 optical coupler 26B outputs the Y polarized wave optical signal L_{Y2} to the polarization rotator 27. The polarization rotator 27 rotates the polarization plane of the Y polarized wave optical signal L_{Y2} by 90° and outputs the signal to the polarization beam coupler 28.

The polarization beam coupler 28 multiplexes the X polarized wave optical signal L_{X2} and the Y polarized wave optical signal L_{Y2} to the DP-QPSK-modulated optical signal OUT having the wavelength λ2. Then, the polarization beam coupler 28 outputs the optical signal OUT.

As described above, the wavelength converter 100 can convert the DP-QPSK-modulated optical signal IN having the wavelength λ1 into the DP-QPSK-modulated optical signal OUT having the wavelength λ2.

Next, measurement of the skew occurring in the optical signal OUT by wavelength conversion in the wavelength converter 100 is described. The wavelength converter 100 receives the DP-QPSK-modulated optical signal IN having the wavelength λ1 in the reception unit 10 and converts the optical signal IN into analog signals of four phases of XI, XQ, YI, and YQ. Then, the transmission unit 20 multiplexes the optical signals of four phases modulated based on the analog signals of four phases and converts the multiplexed signal into the DP-QPSK-modulated optical signal OUT having the wavelength λ2. At this time, if there is no skew associated with the wavelength conversion in the wavelength converter 100, each phase of the optical signal IN is regenerated as each phase of the optical signal OUT as it was.

However, due to a difference in route lengths of the signals of four phases passing through the wavelength converter 100 and the like, variations in delay time by the wavelength converter 100, so-called skew may occur in the optical signals of the phases subjected to wavelength conversion. In this case, even if the optical signal of each phase after the wavelength conversion is multiplexed with the optical signal OUT, the signal of each phase is disturbed, and the signal quality is deteriorated. In order to prevent deterioration in signal quality due to the wavelength conversion, it is required to measure skew occurring in the optical signal OUT after wavelength conversion, and take measures such as optimization of the design of the transmission path lengths of the signals in the wavelength converter 100 so that the delay time in the phases due to wavelength conversion is equalized.

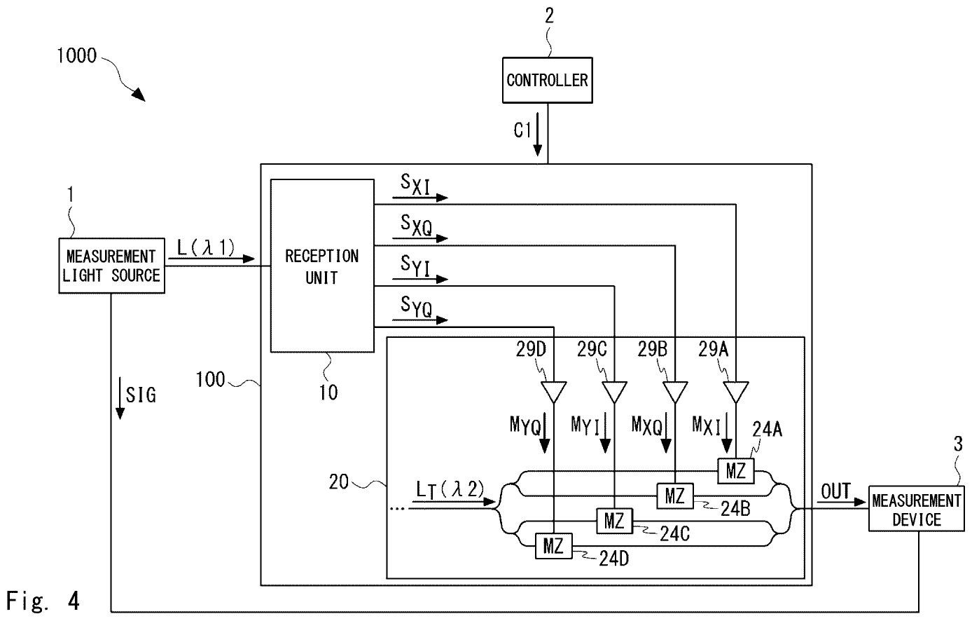

Hereinafter, a measurement system for measuring skew of an optical signal by the wavelength converter 100 is described. FIG. 4 is a diagram schematically illustrating a configuration of the measurement system of skew occurring in the wavelength converter according to one example embodiment. A measurement system 1000 is configured with a measurement light source 1, a controller 2, and a measuring device 3.

The measurement light source 1 outputs a measurement optical signal L of which the amplitude cyclically changes to the wavelength converter 100. Here, it is assumed that the measurement light source 1 outputs the optical signal L of which the amplitude changes in a sinusoidal shape. Hereinafter, the optical signal L is also referred to as a first optical signal. The optical signal L only needs to be subjected to intensity modulation so as to have periodicity and may be various optical signals subjected to intensity modulation such as a pulse wave, in addition to a sine wave.

The controller 2 controls the operation of the wavelength converter 100 between measurements by providing a control signal C1. As a result, the wavelength converter 100 limits the phases included in the optical signal OUT output from the transmission unit 20 to only any one phase of XI, XQ, YI, and YQ and sequentially switches the included phases. Thus, the measuring device 3 independently measures the waveforms of the phases of XI, XQ, YI, and YQ by wavelength conversion. Hereinafter, the optical signal OUT at the time of skew measurement is also referred to as a second optical signal.

The measuring device 3 measures a delay time difference occurring between peaks of waveforms of phases of XI, XQ, YI, and YQ. The measuring device 3 may measure the waveforms of the phases of XI, XQ, YI, and YQ according to a timing signal SIG output from the measurement light source 1. Also, the measuring device 3 may output a measurement result RES to the controller 2.

The controller 2 may control a measurement operation in the measuring device 3. Also, the controller 2 may set the cycle of L by applying a control signal to the measurement light source 1.

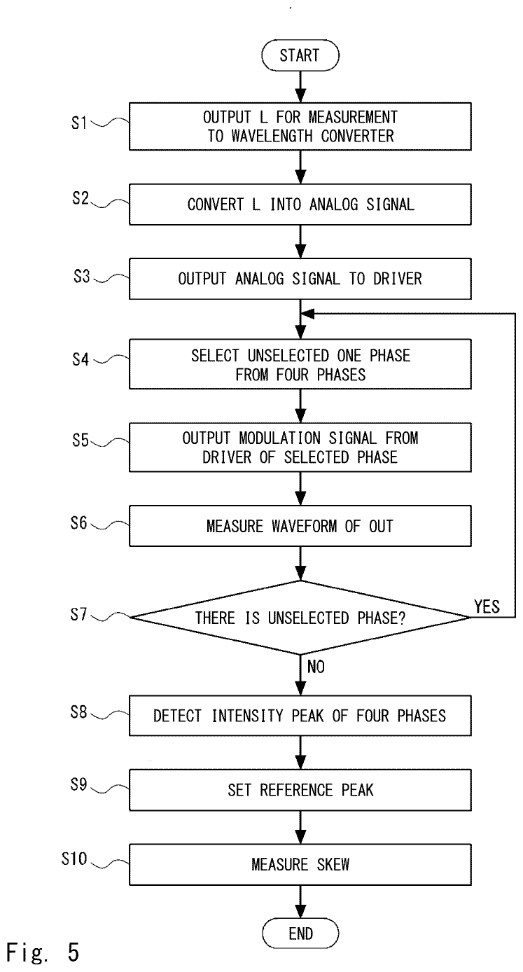

Next, the skew measurement in the wavelength converter 100 is described. FIG. 5 is a flowchart illustrating measurement of the skew occurring in the wavelength converter according to one example embodiment.

### Step S1

The optical signal L having a predetermined periodicity, which is a laser beam for skew measurement, is output from the measurement light source 1 to the wavelength converter 100.

### Step S2

The reception unit 10 separates the optical signal L into four phases of XI, XQ, YI, and YQ and converts the signal into the analog signals of each phase.

### Step S3

The analog signals of each phase are output to the drivers 29A to 29D of the transmission unit 20 via the analog compensation unit 30.

### Step S4

The controller 2 selects one unmeasured phase out of the four phases.

### Step S5

The controller 2 controls the reception unit 10 and the transmission unit 20 so that the modulation signals from drivers of phases other than the selected phase become 0. Here, it is assumed that the controller 2 controls each driver so that the modulation signal from the driver of the phase other than the selected phase becomes 0 regardless of the analog signal input to the drivers 29A to 29D. As a result, the modulator associated to the selected phase performs the modulation operation according to the modulation signal, and the other modulators enter the extinction state without performing the modulation operation.

Note that the controller 2 may control the reception unit 10 so that the amplitude of the analog signal of a phase other than the selected phase becomes 0. As a result, similarly, the modulation signal from the driver of phases other than the selected phase becomes zero. As a result, similarly, the modulator associated to the selected phase performs a modulation operation according to the modulation signal, and the other modulators enter the extinction state without performing the modulation operation.

### Step S6

As a result, only the optical signal of the phase selected by the controller 2 is selectively included in the optical signal OUT output from the transmission unit 20. In this state, the measuring device 3 measures the waveform of the optical signal of the selected phase according to the timing signal SIG output from the measurement light source 1.

### Step S7

After the waveform of the selected phase is measured, it is determined whether there is a phase that has not yet been selected as a measurement object. If there is a phase that has not yet been selected as a measurement object, the process returns to step S4. The determination here may be appropriately performed by the controller 2 or the measuring device 3.

### Step S8

In a case where all the phases are selected as the measurement object, an intensity peak is detected in each of the measured waveforms of the four phases.

### Step S9

One phase is selected from the measured four phases as a reference phase, and an intensity peak of the selected reference phase is set as a reference peak. Note that the waveform of the reference phase is also referred to as a first waveform.

### Step S10

The reference peak and the intensity peaks of the other phases are compared, and the skew is measured based on the delay time difference between the reference peak and each of the peaks of the other phases. Note that the waveform of the other phase is also referred to as a second waveform. Thereafter, the process is ended.

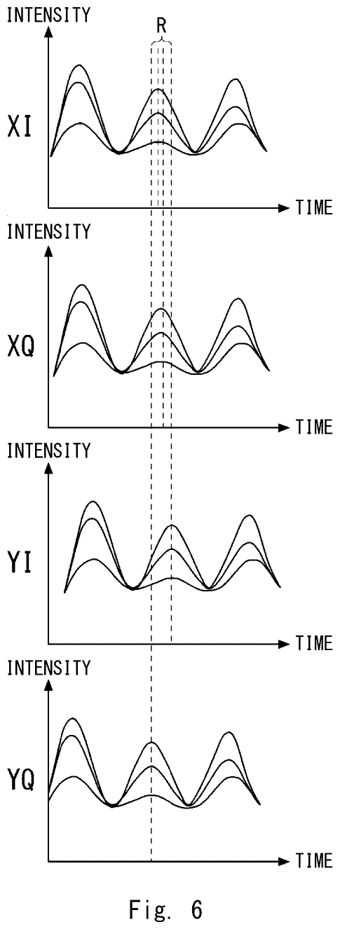

By the above procedure, the waveforms of the optical signals of the phases of XI, XQ, YI, and YQ can be measured by the measuring device 3. FIG. 6 is a diagram illustrating a waveform of an optical signal of each phase output from the wavelength converter according to one example embodiment. In the measurement, since the amplitude of the optical signal L input to the wavelength converter 100 changes to the sinusoidal shape, the amplitude of the measured waveform of the optical signal of each phase also changes to the sinusoidal shape. In addition, in the waveform of the optical signal of each phase, the intensity of the peak temporally fluctuates due to the deviation of the phase between the local oscillation light LO used for the detection of the optical signal L in the reception unit 10 and the optical signal L. In FIG. 6, in order to express the temporal variation of the intensity of the peak, three waveforms having different intensities are displayed in an overlapping manner for each phase.

In the optical signal of each phase, the peak position of the waveform varies due to a difference in delay time due to wavelength conversion in the wavelength converter 100. In FIG. 6, the delay time of each phase varies within a range R. In this example, the peak of XQ is delayed with respect to the peak of XI. The peak of YI is further delayed with respect to the peak of XI. Also, the peak of XI is delayed with respect to the peak of YQ. For example, assuming that XI is a reference phase in step S9 of FIG. 5, delay time of XQ, YI, and YQ with respect to XI can be measured as in step S10 of FIG. 5.

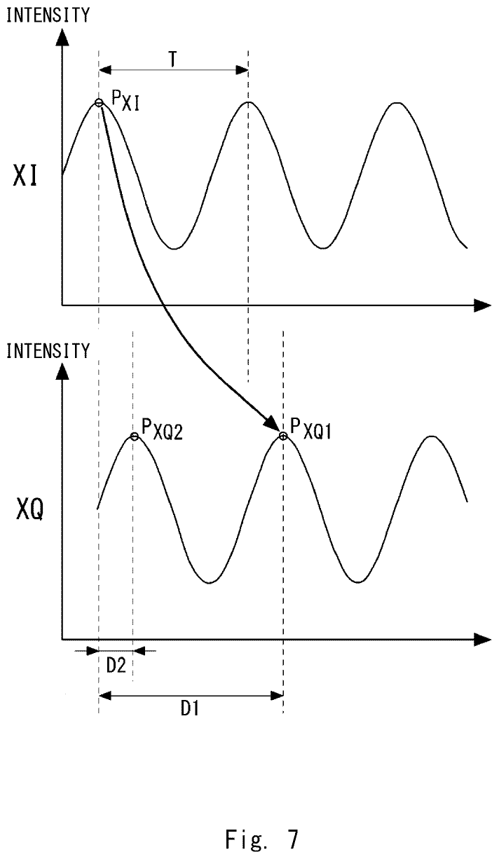

Note that if the delay time between the two phases is longer than the cycle of the optical signal L, there is a case where accurate delay time cannot be measured. FIG. 7 is a diagram illustrating a measured waveform in a case where the delay time difference between two phases is larger than a cycle of the optical signal.

As illustrated in FIG. 7, it is assumed that a delay time difference D1 of XQ with respect to XI is larger than a cycle T of the optical signal L and smaller than twice the cycle T. In this case, a peak P_{XQ1} of XQ associated to a peak P_{XI} of XI appears at a timing delayed from the peak P_{XI} of XI by a value D1 larger than the cycle T. However, since the peak P_{XQ2} appears at the timing delayed by a value D2 smaller than the cycle T before the peak P_{XQ1} by the cycle T, it may be unclear whether the peak of XQ associated to the peak P_{XI} of XI is the peak P_{XQ1} or P_{XQ2}.

Therefore, in order to accurately measure the delay time of each phase, the cycle of the optical signal L is desirably longer than the maximum value of the measured delay time differences of the four phases. The maximum value of the delay time difference may be obtained from design information about the wavelength converter 100 or the like.

In addition, by measuring the delay time illustrated in FIG. 5 using the optical signal L having a sufficiently long cycle, the cycle of the optical signal L may be set so as not to be shorter than the maximum delay time difference. However, since the cycle of the optical signal L and the measurement accuracy of the delay time difference are in a trade-off relationship, it is desirable to set the cycle of the optical signal L not to be excessively long.

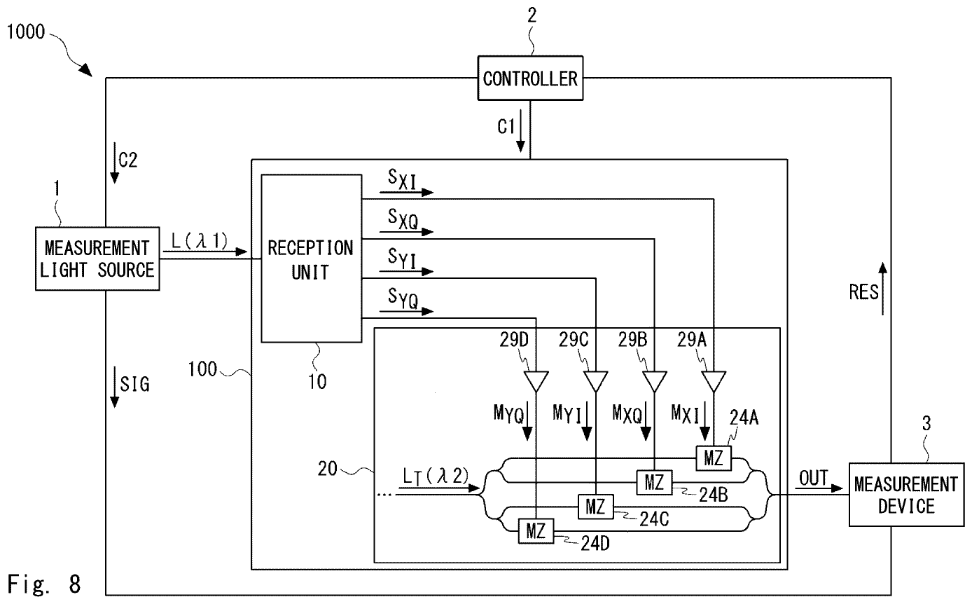

Hereinafter, adjustment of the cycle of the optical signal L in the measurement system 1000 is described. FIG. 8 is a diagram schematically illustrating a configuration of the measurement system according to one example embodiment. As illustrated in FIG. 8, the controller 2 can set the cycle of the optical signal L output from the measurement light source 1 by a control signal C2. Also, the measuring device 3 outputs the measurement result RES of the waveform of each phase to the controller 2.

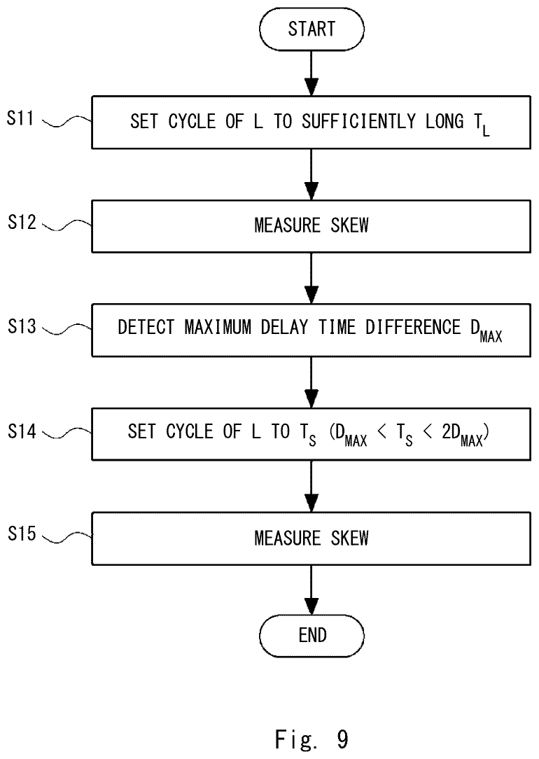

Hereinafter, an adjustment operation of the cycle of the optical signal Lin the measurement system 1000 is described. FIG. 9 is a flowchart illustrating a determination method of the cycle of the optical signal.

### Step S11

First, the controller 2 sets a sufficiently long value T_{L} as the cycle of the optical signal L in the measurement light source 1.

### Step S12

The controller 2 controls the measurement system 1000 to perform skew measurement similarly to FIG. 5.

### Step S13

The measuring device 3 detects a maximum delay time difference D_{MAX} based on the measurement result. The maximum delay time difference D_{MAX} measured here is a value with low measurement accuracy because a cycle T_{L} of the optical signal L is sufficiently long. The measuring device 3 notifies the controller 2 of the detected maximum delay time difference D_{MAX} as the measurement result RES.

### Step S14

In order to measure the delay time difference with higher accuracy, the controller 2 sets an appropriate cycle T_{S} shorter than T_{L} as the cycle of the optical signal L in the measurement light source 1. For example, the appropriate cycle T_{S} may be a value larger than the maximum delay time difference D_{MAX} and smaller than twice the maximum delay time difference D_{MAX}.

### Step S15

The controller 2 controls the measurement system 1000 to perform skew measurement similarly to FIG. 5.

As a result, in step S15, since a value that is longer than the maximum delay time difference but is close to the maximum delay time difference is set as the cycle of the optical signal L, the delay time difference between the reference phase and each phase can be measured with high accuracy.

As described above, according to the present configuration, it is possible to measure variation in delay time of each phase included in the optical signal OUT output from the wavelength converter 100, that is, skew. In addition, according to this configuration, it is possible to easily measure the skew in the optical signal after the wavelength conversion only by controlling the operation of the modulator without changing the configuration of the wavelength converter.

Meanwhile, in WO 2011/145712 A1, it is possible to measure the skew of each phase occurring in the receiver. However, it is not possible to measure the skew of the optical signal of each phase after being multiplexed by the transmitter originally. Therefore, this configuration is advantageous in that the skew of the optical signal of each phase after being multiplexed by the transmitter can be measured.

In addition, as disclosed in US 2017/324476 A, the intensity of the optical signal after the wavelength conversion may change due to the influence of the frequency and phase of the optical signal input to the receiver and the frequency deviation between the input signal and the local oscillation light. However, according to this configuration, since the delay time difference is measured by the peak position of the waveform of the optical signal of each phase after the wavelength conversion, it is advantageous in that more robust skew measurement to the intensity change of the waveform can be performed.

Note that, in the present example embodiment, it has been described that the measurement system 1000 does not include the wavelength converter 100, but the measurement system 1000 may be configured to include the wavelength converter 100.

### Second Example Embodiment

Next, skew measurement according to a second example embodiment is described. In the first example embodiment, the measurement accuracy of the delay time of each phase may be influenced depending on the polarization state of the light L output from the measurement light source 1. For example, depending on the relative relationship between the polarization axis of the optical signal L output from the measurement light source 1 and the polarization axis of the wavelength converter 100, the intensity of the optical signal OUT output from the wavelength converter 100 may decrease. In a case where the intensity of the optical signal of each phase included in the optical signal OUT output from the wavelength converter 100 decreases at the time of skew measurement, the decrease leads to deterioration of measurement accuracy of the delay time. Therefore, it is desirable that the intensity of the optical signal of each phase included in the optical signal OUT is maintained at a certain level or more. Therefore, in the present example embodiment, a measurement system capable of maintaining the intensity of the optical signal of each phase included in the optical signal OUT at a certain level or more is described.

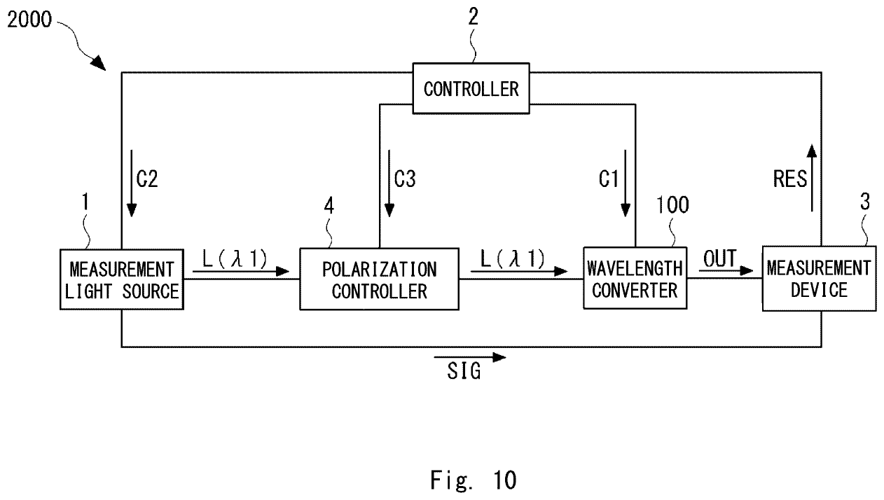

FIG. 10 is a diagram illustrating a configuration of the measurement system according to one example embodiment. A measurement system 2000 has a configuration in which a polarization controller 4 is inserted between the measurement light source 1 and the wavelength converter 100 in the measurement system 1000 according to the first example embodiment.

The polarization controller 4 is configured to be able to adjust the polarization axis of the optical signal L. At this time, the polarization controller 4 may adjust the polarization axis of the optical signal L so that the intensity of one or both of the X polarized wave and the Y polarized wave included in the optical signal OUT is larger than a predetermined value. In addition, the polarization controller 4 may adjust the polarization axis of the optical signal L so that the intensities of both the X polarized wave and the Y polarized wave included in the optical signal OUT fall within a predetermined range. More desirably, the polarization controller 4 may adjust the polarization axis of the optical signal L so that the intensities of both the X polarized wave and the Y polarized wave included in the optical signal OUT are within a range that can be regarded as matching.

The controller 2 may monitor the intensity of the optical signal OUT received by the measuring device 3. Then, the controller 2 may perform feedback control on the polarization axis of the optical signal L in the polarization controller 4 by providing a control signal C3 according to the monitoring result.

According to this configuration, by adjusting the polarization axis of the optical signal L in the polarization controller 4, the intensity of one or both of the X polarized wave and the Y polarized wave included in the optical signal OUT can be controlled to a suitable value. As a result, the skew measurement accuracy of the optical signal can be improved.

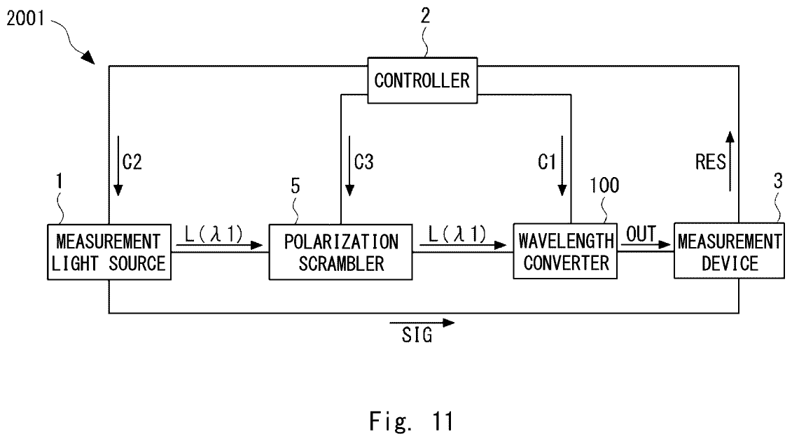

Although the case of using the polarization controller 4 is described above, the adjustment means for the polarization axis of the optical signal L is not limited thereto. FIG. 11 is a diagram illustrating a modified example of the measurement system according to one example embodiment. A measurement system 2001 has a configuration in which the polarization controller 4 of the measurement system 2001 is replaced with a polarization scrambler 5.

The polarization scrambler 5 is configured to be able to rotate the polarization axis of the optical signal L. As a result, by temporally fluctuating the intensity of the optical signal of each phase measured by the measuring device 3, a peak having a magnitude suitable for measuring the delay time can be formed in the waveform of the optical signal. In addition, by taking the temporal average of the waveform, the intensity variation may be smoothed due to the polarization rotation.

The controller 2 may monitor the intensity of the optical signal OUT received by the measuring device 3. Then, the controller 2 may perform feedback control on the rotation speed, the rotation direction, and the like of the polarization axis of the optical signal L of the polarization scrambler 5 by providing the control signal C3 according to the monitoring result.

According to this configuration, by controlling the rotation of the polarization axis of the optical signal L in the polarization scrambler 5, a peak of suitable intensity can be formed in the waveform of one or both of the X polarized wave and the Y polarized wave included in the optical signal OUT. As a result, the measurement accuracy of the delay time of the optical signal in the skew measurement can be improved.

### Third Example Embodiment

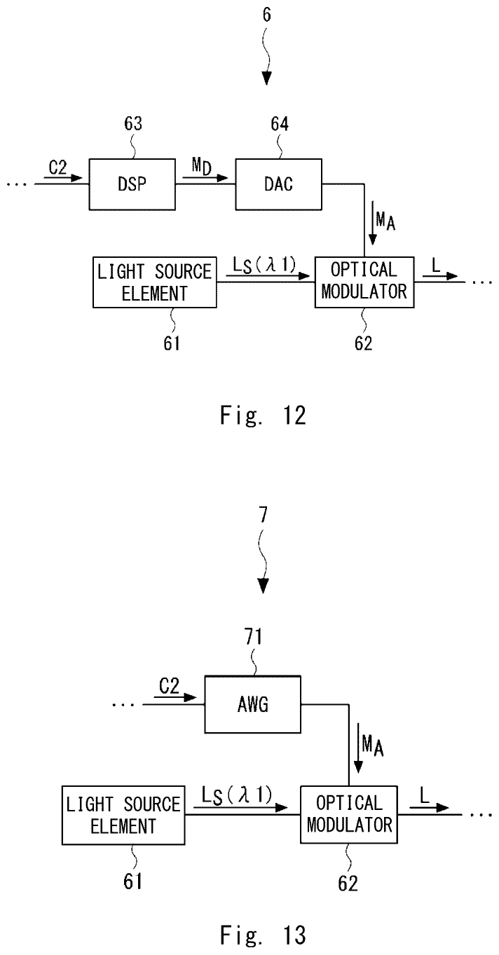

In the present example embodiment, a measurement light source is described. The measurement light source may be configured as a coherent transmitter. FIG. 12 is a diagram schematically illustrating a first configuration example of a measurement light source. The measurement light source 6 is configured with a light source element 61, a modulator 62, a digital signal processor (DSP) 63, and a digital to analog converter (DAC) 64.

The light source element 61 may be configured as, for example, a semiconductor laser device. The light source element 61 outputs light L_{S}, which is, for example, a continuous oscillation laser beam, to the modulator 62. The DSP 63 outputs a digital modulation signal M_{D} to the DAC 64. The DAC 64 is configured as a driver of the modulator 62. The DAC 64 converts the digital modulation signal M_{D} into an analog modulation signal M_{A}. Then, the DAC 64 outputs the analog modulation signal M_{A} to the modulator 62.

The modulator 62 is configured as, for example, various optical modulators such as a Mach-Zehnder optical modulator. The modulator 62 outputs the optical signal L of which the amplitude changes, for example, in a sinusoidal shape by modulating the light L_{S} according to the analog modulation signal M_{A}.

Note that the DSP 63 may output the digital modulation signal M_{D} having a cyclic arbitrary waveform by being controlled by the control signal C2. As a result, the waveform of the optical signal L output from the modulator 62 can be an arbitrary waveform having periodicity such as a pulse wave, in addition to a sine wave.

The measurement light source may be a coherent transmitter of another configuration. FIG. 13 is a diagram schematically illustrating a second configuration example of the measurement light source. A measurement light source 7 has a configuration in which the DSP 63 and the DAC 64 of the measurement light source 6 are replaced with an arbitrary waveform generator (AWG) 71.

The AWG 71 outputs, to the modulator 62, the analog modulation signal M_{A} having an arbitrary waveform selected by the user, for example, among waveforms recorded in advance. The AWG 71 may output the analog modulation signal M_{A} having a cyclic arbitrary waveform by being controlled by the control signal C2. As a result, the modulator 62 can output the optical signal L having an arbitrary waveform having periodicity such as a sine wave or a pulse wave by modulating the light L_{S} according to the analog modulation signal M_{A}.

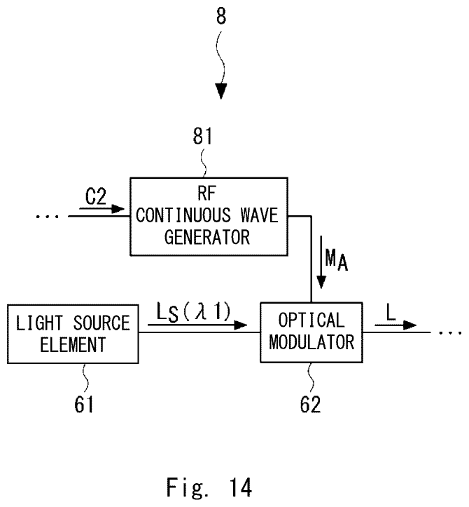

FIG. 14 is a diagram schematically illustrating a third configuration example of the measurement light source. A measurement light source 8 has a configuration in which the DSP 63 and the DAC 64 of the measurement light source 6 are replaced with an RF continuous wave (CW) generator 81.

The RF continuous wave generator 81 outputs an RF wave having a frequency in a predetermined range to the modulator 62 as the analog modulation signal M_{A}. The RF continuous wave generator 81 may output the analog modulation signal M_{A} having a cyclic waveform by being controlled by the control signal C2. As a result, the modulator 62 can output the optical signal L having an arbitrary waveform having periodicity such as a sine wave by modulating the light L_{S} according to the analog modulation signal M_{A}.

As described above, even in a case where the coherent transmitter is used as the measurement light source, the skew of the optical signal OUT output from the wavelength converter 100 can be measured as in the first and second example embodiments.

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

In the above example embodiment, the wavelength conversion of the optical signal including the four DP-QPSK-modulated phases is described, but the modulation scheme of the optical signal that can be provided is not limited thereto. As long as the receiver can perform coherent detection, the measurement system according to the above-described example embodiment may be applied to an optical signal having a plurality of phases other than four. In addition, the optical signal may be subjected to polarization modulation or may not be subjected to polarization modulation.

Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other figures, for example, to create an example embodiment that is not explicitly illustrated or described. All of the features or the steps illustrated in any one of the drawings for describing illustrative example embodiments are not necessarily mandatory, and some features or steps may be omitted. The order of the steps described in any of the figures may be changed as appropriate.

Some or all of the above example embodiments can also be described as the following Supplementary Notes, but are not limited to the following.

### (Supplementary Note 1)

A measurement system including:
a light source that outputs a first optical signal having a first wavelength to a reception means of a wavelength converter configured with the reception means for coherently detecting an input optical signal having the first wavelength and outputting a plurality of analog signals associated to a plurality of phases included in the input optical signal having the first wavelength and a transmission means for multiplexing a plurality of optical signals and outputting the optical signals, the transmission means including a drive means for outputting a plurality of modulation signals according to the plurality of analog signals and a plurality of modulation means for modulating light having a second wavelength different from the first wavelength to the plurality of optical signals associated to the plurality of phases according to the plurality of modulation signals;
a control means for controlling the wavelength converter in a state in which the first optical signal is output to the reception means, so that one specific modulation means among the plurality of modulation means outputs an optical signal associated to one phase, the optical signal obtained by modulating the light having the second wavelength, the modulation means other than the specific modulation means do not output optical signals associated to phases other than the one phase, and the specific modulation means is sequentially switched among the plurality of modulation means; and
a measurement means for receiving a second optical signal output from the transmission means in a state in which the first optical signal is output to the reception means, acquiring waveforms of optical signals associated to the plurality of phases selectively included in the second optical signal in response to the switching of the specific modulation means, and measuring skew occurring in the optical signals associated to the plurality of phases based on intensities of the acquired waveforms of the optical signals associated to the plurality of phases.

### (Supplementary Note 2)

The measurement system according to Supplementary Note 1, in which the first optical signal is an optical signal of which an intensity cyclically changes.

### (Supplementary Note 3)

The measurement system according to Supplementary Note 2, in which the first optical signal is an optical signal having a waveform in a sinusoidal shape or a pulsed optical signal.

### (Supplementary Note 4)

The measurement system according to Supplementary Note 2, in which the measurement means measures a delay time difference between a first peak of a first waveform among the waveforms of the optical signals associated to the plurality of phases and a second peak associated to the first peak in a second waveform.

### (Supplementary Note 5)

The measurement system according to Supplementary Note 4, in which a cycle of the intensity modulation is a value larger than a maximum value of the delay time differences measured for all sets of the first waveform and the second waveform selected from the waveforms of the optical signals associated to the plurality of phases.

### (Supplementary Note 6)

The measurement system according to Supplementary Note 4, in which the control means sets a first cycle as a cycle of the intensity modulation in the light source,
the measurement means acquires a maximum value among the delay time differences measured for all sets of the first waveform and the second waveform selected from the waveforms of the optical signals associated to the plurality of phases with respect to the first optical signal of the first cycle and outputs the acquired maximum value to the control means, and
the control means sets a second cycle longer than the maximum value received from the measurement means and the first cycle as a cycle of the intensity modulation.

### (Supplementary Note 7)

The measurement system according to Supplementary Note 6, in which the control means sets a cycle shorter than twice the maximum value received from the measurement means as the second cycle.

### (Supplementary Note 8)

The measurement system according to any one of Supplementary Notes 1 to 7, in which the control means controls output of the plurality of modulation signals from the drive means to the plurality of modulation means so that the modulation means other than the specific modulation means are brought into an extinction state.

### (Supplementary Note 9)

The measurement system according to any one of Supplementary Notes 1 to 7, in which the control means controls output of the plurality of analog signals from the reception means to the drive means so that the modulation means other than the specific modulation means are brought into an extinction state.

### (Supplementary Note 10)

The measurement system according to any one of Supplementary Notes 1 to 9, in which the first optical signal is an optical signal subjected to phase shift modulation.

### (Supplementary Note 11)

The measurement system according to Supplementary Note 10, in which the first optical signal is an optical signal subjected to polarization multiplexing.

### (Supplementary Note 12)

The measurement system according to any one of Supplementary Notes 1 to 11, further including: a polarization control means inserted between the measurement means and the wavelength converter, in which the control means controls a polarization state of the first optical signal by the polarization control means so that the optical signal associated to the plurality of phases included in the second optical signal has a desired intensity.

### (Supplementary Note 13)

The measurement system according to any one of Supplementary Notes 1 to 12, in which the light source is configured as a coherent optical transmitter, modulates light having the first wavelength, and outputs the first optical signal.

### (Supplementary Note 14)

A measurement system including:
a wavelength converter configured with a reception means for coherently detecting an input optical signal having a first wavelength and outputting a plurality of analog signals associated to a plurality of phases included in the input optical signal having the first wavelength and a transmission means for multiplexing a plurality of optical signals and outputting the optical signals, the transmission means including a drive means for outputting a plurality of modulation signals according to the plurality of analog signals and a plurality of modulation means for modulating light having a second wavelength different from the first wavelength to the plurality of optical signals associated to the plurality of phases according to the plurality of modulation signals;
a light source that outputs a first optical signal having the first wavelength to the reception means;
a control means for controlling the wavelength converter in a state in which the first optical signal is output to the reception means, so that one specific modulation means among the plurality of modulation means outputs an optical signal associated to one phase, the optical signal obtained by modulating the light having the second wavelength, the modulation means other than the specific modulation means do not output optical signals associated to phases other than the one phase, and the specific modulation means is sequentially switched among the plurality of modulation means; and
a measurement means for receiving a second optical signal output from the transmission means in a state in which the first optical signal is output to the reception means, acquiring waveforms of optical signals associated to the plurality of phases selectively included in the second optical signal in response to the switching of the specific modulation means, and measuring skew occurring in the optical signals associated to the plurality of phases based on intensities of the acquired waveforms of the optical signals associated to the plurality of phases.

### (Supplementary Note 15)

A measurement method including:
outputting a first optical signal having a first wavelength to a reception means of a wavelength converter configured with the reception means for coherently detecting an input optical signal having the first wavelength and outputting a plurality of analog signals associated to a plurality of phases included in the input optical signal having the first wavelength and a transmission means for multiplexing a plurality of optical signals and outputting the optical signals, the transmission means including a drive means for outputting a plurality of modulation signals according to the plurality of analog signals and a plurality of modulation means for modulating light having a second wavelength different from the first wavelength to the plurality of optical signals associated to the plurality of phases according to the plurality of modulation signals;
controlling the wavelength converter in a state in which the first optical signal is output to the reception means, so that one specific modulation means among the plurality of modulation means outputs an optical signal associated to one phase, the optical signal obtained by modulating the light having the second wavelength, the modulation means other than the specific modulation means do not output optical signals associated to phases other than the one phase, and the specific modulation means is sequentially switched among the plurality of modulation means; and
receiving a second optical signal output from the transmission means in a state in which the first optical signal is output to the reception means, acquiring waveforms of optical signals associated to the plurality of phases selectively included in the second optical signal in response to the switching of the specific modulation means, and measuring skew occurring in the optical signals associated to the plurality of phases based on intensities of the acquired waveforms of the optical signals associated to the plurality of phases.

What is claimed is:

1. A measurement system comprising:
a light source that outputs a first optical signal having a first wavelength to a reception unit of a wavelength converter configured with the reception unit that coherently detects an input optical signal having the first wavelength and outputs a plurality of analog signals associated to a plurality of phases included in the input optical signal having the first wavelength and a transmission unit that multiplexes a plurality of optical signals and outputs the optical signals, the transmission unit including a driver that outputs a plurality of modulation signals according to the plurality of analog signals and a plurality of modulators that modulate light having a second wavelength different from the first wavelength to the plurality of optical signals associated to the plurality of phases according to the plurality of modulation signals;
a controller that controls the wavelength converter in a state in which the first optical signal is output to the reception unit, so that one specific modulator among the plurality of modulator outputs an optical signal associated to one phase, the optical signal obtained by modulating the light having the second wavelength, the modulators other than the specific modulator do not output optical signals associated to phases other than the one phase, and the specific modulator is sequentially switched among the plurality of modulators; and
a measurement unit that receives a second optical signal output from the transmission unit in a state in which the first optical signal is output to the reception unit, acquiring waveforms of optical signals associated to the plurality of phases selectively included in the second optical signal in response to the switching of the specific modulation unit, and measuring skew occurring in the optical signals associated to the plurality of phases based on intensities of the acquired waveforms of the optical signals associated to the plurality of phases.

2. The measurement system according to claim 1, wherein the first optical signal is an optical signal of which an intensity cyclically changes.

3. The measurement system according to claim 2, wherein the first optical signal is an optical signal having a waveform in a sinusoidal shape or a pulsed optical signal.

4. The measurement system according to claim 2, wherein the measurement unit measures a delay time difference between a first peak of a first waveform among the waveforms of the optical signals associated to the plurality of phases and a second peak associated to the first peak in a second waveform.

5. The measurement system according to claim 4, wherein a cycle of the intensity modulation is a value larger than a maximum value of the delay time differences measured for all sets of the first waveform and the second waveform selected from the waveforms of the optical signals associated to the plurality of phases.

6. The measurement system according to claim 4, wherein
the control unit sets a first cycle as a cycle of the intensity modulation in the light source,
the measurement unit acquires a maximum value among the delay time differences measured for all sets of the first waveform and the second waveform selected from the waveforms of the optical signals associated to the plurality of phases with respect to the first optical signal of the first cycle and outputs the acquired maximum value to the controller, and
the control controller sets a second cycle longer than the maximum value received from the measurement unit and the first cycle as a cycle of the intensity modulation.

7. The measurement system according to claim 6, wherein the controller sets a cycle shorter than twice the maximum value received from the measurement unit as the second cycle.

8. The measurement system according to claim 1, wherein the controller controls output of the plurality of modulation signals from the driver to the plurality of modulators so that the modulators other than the specific modulator are brought into an extinction state.

9. The measurement system according to claim 1, wherein the controller controls output of the plurality of analog signals from the reception unit to the driver so that the modulators other than the specific modulator are brought into an extinction state.

10. The measurement system according to claim 1, wherein the first optical signal is an optical signal subjected to phase shift modulation.

11. The measurement system according to claim 10, wherein the first optical signal is an optical signal subjected to polarization multiplexing.

12. The measurement system according to claim 1, further comprising a polarization controller inserted between the measurement unit and the wavelength converter,
wherein the controller controls a polarization state of the first optical signal by the polarization controller so that the optical signal associated to the plurality of phases included in the second optical signal has a desired intensity.

13. The measurement system according to claim 1, wherein the light source is configured as a coherent optical transmitter, modulates light having the first wavelength, and outputs the first optical signal.

14. A measurement system comprising:
a wavelength converter configured with a reception unit that coherently detects an input optical signal having a first wavelength and outputting a plurality of analog signals associated to a plurality of phases included in the input optical signal having the first wavelength and a transmission unit that multiplexes a plurality of optical signals and outputting the optical signals, the transmission unit including a driver that outputs a plurality of modulation signals according to the plurality of analog signals and a plurality of modulators that modulate light having a second wavelength different from the first wavelength to the plurality of optical signals associated to the plurality of phases according to the plurality of modulation signals;
a light source that outputs a first optical signal having the first wavelength to the reception unit;
a controller that controls the wavelength converter in a state in which the first optical signal is output to the reception unit, so that one specific modulator among the plurality of modulators outputs an optical signal associated to one phase, the optical signal obtained by modulating the light having the second wavelength, the modulators other than the specific modulator do not output optical signals associated to phases other than the one phase, and the specific modulator is sequentially switched among the plurality of modulators; and
a measurement unit that receives a second optical signal output from the transmission unit in a state in which the first optical signal is output to the reception unit, acquiring waveforms of optical signals associated to the plurality of phases selectively included in the second optical signal in response to the switching of the specific modulator, and measuring skew occurring in the optical signals associated to the plurality of phases based on intensities of the acquired waveforms of the optical signals associated to the plurality of phases.

15. A measurement method comprising:
outputting a first optical signal having a first wavelength to a reception unit of a wavelength converter configured with the reception unit that coherently detects an input optical signal having the first wavelength and outputting a plurality of analog signals associated to a plurality of phases included in the input optical signal having the first wavelength and a transmission unit that multiplexes a plurality of optical signals and outputting the optical signals, the transmission unit including a driver that outputs a plurality of modulation signals according to the plurality of analog signals and a plurality of modulators that modulate light having a second wavelength different from the first wavelength to the plurality of optical signals associated to the plurality of phases according to the plurality of modulation signals;
controlling the wavelength converter in a state in which the first optical signal is output to the reception unit, so that one specific modulator among the plurality of modulators outputs an optical signal associated to one phase, the optical signal obtained by modulating the light having the second wavelength, the modulators other than the specific modulator do not output optical signals associated to phases other than the one phase, and the specific modulator is sequentially switched among the plurality of modulators; and
receiving a second optical signal output from the transmission unit in a state in which the first optical signal is output to the reception unit, acquiring waveforms of optical signals associated to the plurality of phases selectively included in the second optical signal in response to the switching of the specific modulator, and measuring skew occurring in the optical signals associated to the plurality of phases based on intensities of the acquired waveforms of the optical signals associated to the plurality of phases.
